(19) United States
(12) Patent Application Publication
(10) Pub. No.: US 2008/0101563 A1
(43) Pub. Date: May 1, 2008

(54) Selectable voice prompts

(76) Inventor: Jeffrey B. Smith, Veradale, WA (US)

Correspondence Address: SADLER, BREEN, MORASCH & COLBY, P.S., 422 W. RIVERSIDE AVE., SUITE 424, SPOKANE, WA, 99201, US

(21) Appl. No.: 11/591,389

(22) Filed: Nov. 1, 2006

(51) Int. Cl. H04M 11/00

(52) U.S. Cl. 379/88.18

(57) ABSTRACT

In an embodiment of selectable prompts, selectable identifiers can be selected to describe a commodity via parsed voice prompts that correspond to selected ones of the selectable identifiers. A description of the commodity can then be generated from the parsed voice prompts that correspond to the selected ones of the selectable identifiers, and the description of the commodity can be provided when requested.

### BACKGROUND

Some telephone switching systems provide a feature that allows a caller to call into a switching system and retrieve numeric database information via voice prompts. This is commonly used and recognized in the banking industry. A bank's customer can call into a voice response system and enter an account number and password to receive voice prompts that communicate information regarding checks paid, deposits made, current account balance, and the like. This information is communicated to the caller using “parsed voice prompts” which are segments of word(s) and number information played-back in an ordered sequence.

For example, a bank customer may have a current account balance of $123.00 which will be communicated to the customer when requested as the following parsed voice prompts played together in succession:

Prompt 1: “Your current balance is”

Prompt 2: “One”

Prompt 3: “Hundred”

Prompt 4: “Twenty”

Prompt 5: “Three”

Prompt 6: “Dollars, and”

Prompt 7: “Zero”

Prompt 8: “Cents”

Parsed voice prompts are also conventionally utilized for voice mail systems, such as when a caller initiates a check of his or her voice mail for messages. The caller may hear a communication such as: “You have”, “Two”, “New Messages”, “And”, “Three”, “Saved Messages”. Each voice prompt is a unique segmented message that, when successively played with other individual voice prompts, seamlessly and smoothly communicates the information to the voice mail customer.

The voice mail service industry provides recording services to the real estate and mortgage industries, for example. Real estate agents and mortgage loan agents routinely utilize the recording services to provide recorded voice messages about a particular home that is for sale as well as loan information that may be currently available to purchase the home. For example, a real estate agent who is commissioned to sell a home can record what is commonly referred to as a “voice mail greeting” message to detail specifics about the home which is listed for sale. An example voice mail greeting message might sound something like:
“This home is close to schools. It is a three bedroom, two bath home and has a two car garage, swimming pool, and a large deck. It has a nice dining room and a kitchen that includes granite counter tops and new cabinets. The carpet is only two years old, and fireplaces are located both upstairs and downstairs . . . .”

Recording voice mail greeting messages is currently a very tedious task for real estate agents and mortgage loan agents, and not only to record the information, but also to keep the information in the recorded greeting messages up-to-date. For example, if a home owner asks for a change to the information in a recorded greeting message, or if the selling price of the home is reduced, then the real estate agent has to re-record the entire message to incorporate the change. Similarly, if a mortgage loan rate changes, the entire loan information message must be re-recorded.

### SUMMARY

This summary is provided to introduce simplified concepts of selectable voice prompts which is further described below in the Detailed Description. This summary is not intended to identify essential features of the claimed subject matter, nor is it intended for use in determining the scope of the claimed subject matter.

In an embodiment of selectable voice prompts, selectable identifiers can be selected to describe a commodity via parsed voice prompts that correspond to selected ones of the selectable identifiers. A description of the commodity can then be generated from the parsed voice prompts that correspond to the selected ones of the selectable identifiers, and the description of the commodity can be provided when requested.

In other embodiment(s) of selectable voice prompts, the selectable identifiers can be selected via a Web-based user interface. The selectable identifiers can be descriptive real-estate terms from which a description of real-estate is generated with corresponding parsed voice prompts. Alternatively, the selectable identifiers can be descriptive automotive terms from which a description of a vehicle is generated with corresponding parsed voice prompts. Alternatively, the selectable identifiers can be descriptive medical terms from which a description of a medical-related state is generated with corresponding parsed voice prompts. The description of a commodity, real-estate, vehicle, medical-related state, or any other type of description can be requested and received as an audio rendition of the parsed voice prompts.

### BRIEF DESCRIPTION OF THE DRAWINGS

The same numbers are used throughout the drawings to reference like features and components:

FIG. 1 illustrates an example selectable voice prompts system in which embodiment(s) of selectable voice prompts can be implemented.

FIG. 2 illustrates examples of various devices which can be implemented in embodiment(s) of selectable voice prompts as communication, interface, and/or computing-based devices.

FIG. 3 illustrates example implementation(s) of selectable voice prompts.

FIG. 4 illustrates exemplary method(s) for selectable voice prompts.

FIG. 5 illustrates an example computing-based device that can be implemented as any one or more devices in a selectable voice prompts system.

### DETAILED DESCRIPTION

Selectable voice prompts is described in which embodiments provide that a description of a commodity can be generated from selectable identifiers, and the description can then be communicated as an audio rendition of parsed voice prompts when requested. As a Web-based service, selectable voice prompts can be implemented and associated with any number of different call-in and/or automated services that provide a service for free or for a fee, such as an information service, technical support service, research database service, and the like that provides recorded information delivered via parsed voice prompts. In one implementation, selectable voice prompts can include an interface for real-estate agents wanting to provide recorded audio descriptions of real-estate properties to prospective customers that call-in to learn about a real-estate listing.

Selectable voice prompts can be implemented as part of any telecommunications system, a public switched telephone network, or as part of any other communication and/or information services system that provides recorded information via any communication device including telephone devices, computing devices, portable playback devices, and the like. While aspects of the described systems and methods for selectable voice prompts can be implemented in any of these systems, embodiments of selectable voice prompts are described in the context of the following exemplary systems and environments.

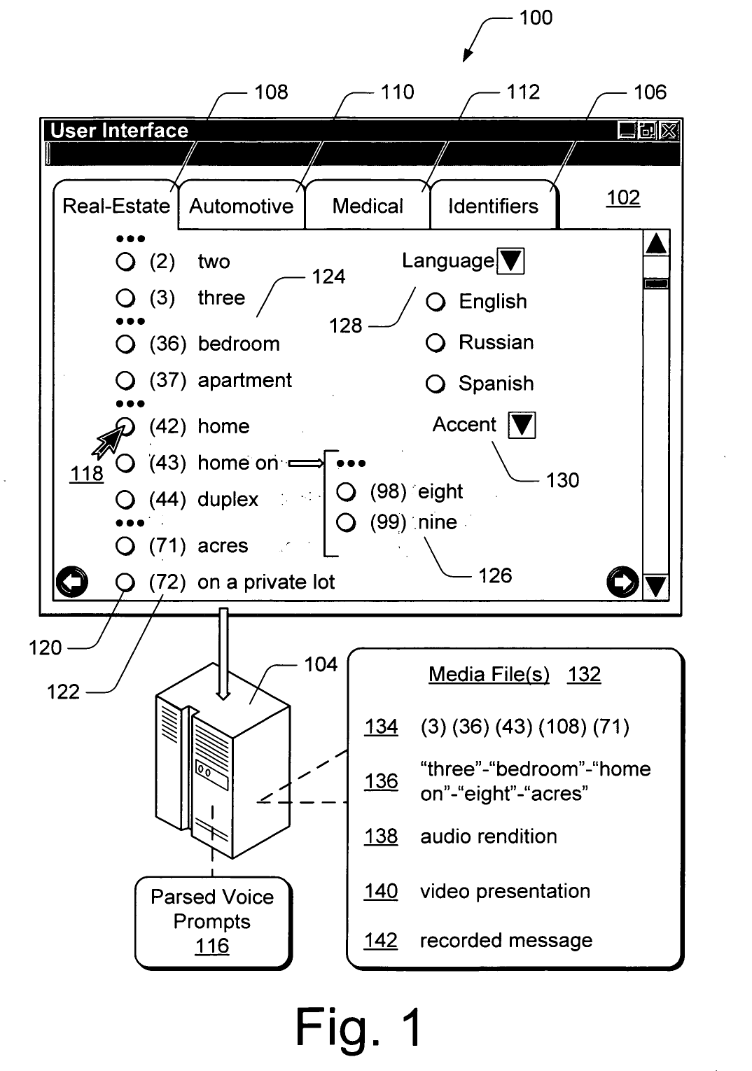

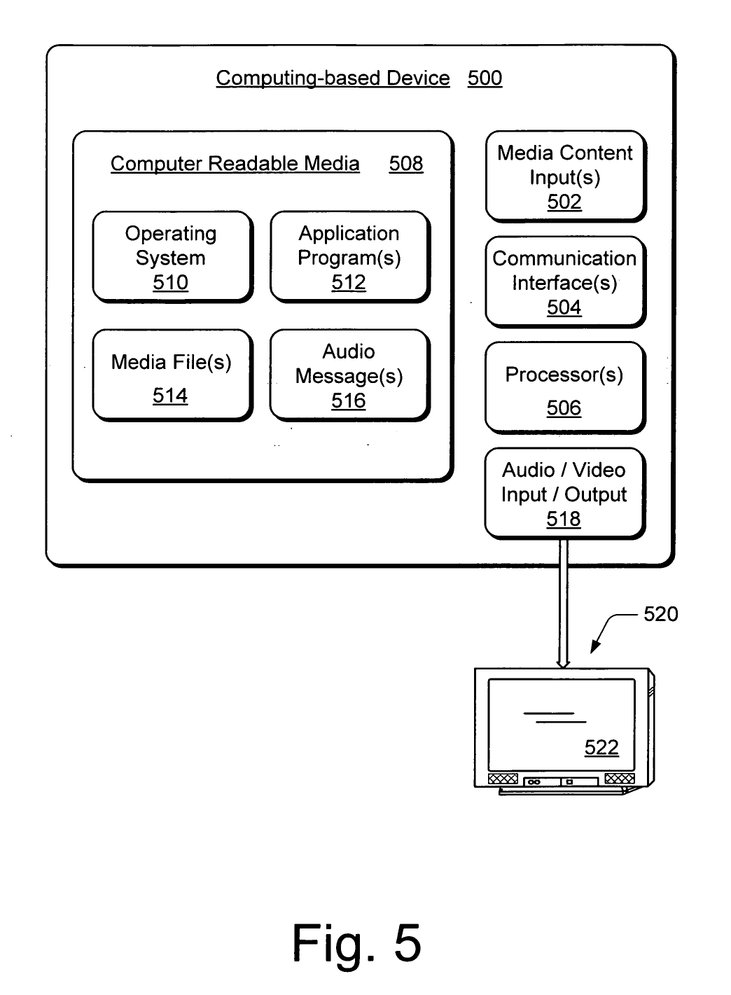

FIG. 1 illustrates an example selectable voice prompts system 100 in which embodiment(s) of selectable voice prompts can be implemented. The selectable voice prompts system 100 includes a user interface 102 and a computing-based device 104 which, in this example, can be implemented as any one or combination of a content server, a telecommunications switch or service, a computer, and the like. Additionally, the computing-based device 104 can be implemented with any one or more of the differing components described below with reference to the example computing-based device shown in FIG. 5.

The user interface 102 can be implemented as any type of Web-based or other device-specific user interface via which user-selectable identifiers can be selected. The user interface 102 can include any type of selectable inputs or identifiers 106, such as one or more of descriptive real-estate terms 108, descriptive automotive terms 110, and descriptive medical terms 112. Although the various selectable identifiers for the real-estate, automotive, and medical industries are included for discussion in this example, a user interface can be implemented with the selectable identifiers for just one industry, such as the selectable, descriptive real-estate terms 108.

The selectable identifiers 106 can be selected to describe a commodity via parsed voice prompts that correspond to selected ones of the identifiers. A description of the commodity can then be generated from the parsed voice prompts that correspond to the selected ones of the identifiers. For example, parsed voice prompts 116 maintained by device 104 that correspond to selected ones of the descriptive real-estate terms 108 can be sequenced to describe real-estate, such as a property, a house, a building, and the like. Similarly, parsed voice prompts 116 that correspond to selected ones of the descriptive automotive terms 110 can be sequenced to describe a vehicle, and parsed voice prompts 116 that correspond to selected ones of the descriptive medical terms 112 can be sequenced to describe a medical-related state, such as a condition, state of health, and the like.

In this example, various descriptive real-estate terms 108 are displayed for user selection on the user interface 102, such as with a pointing device (e.g., clicking with a mouse) to control a selector 118, such as an arrow that moves around the display on the user interface to indicate the movement of a mouse input device. The display of descriptive terms may each include a selection indicator 120, an associated number identifier 122, and any combination of one or more words and numbers 124 that correspond to a parsed voice prompt 116. Alternative embodiments may include any combination and types of various selection indicators, identifiers, and the like displayed on the user interface 102.

Rather than having to record and re-record a real-estate description of a home for sale, a real-estate agent can select various ones of the descriptive real-estate terms 108 from which a description of the home can be generated from corresponding parsed voice prompts 116. For example, a user can select “(3) three”, “(36) bedroom”, “(43) home on”, “(98) eight”, and “(71) acres” to generate an audio description of a “three bedroom home on eight acres”. As in this example, a descriptive term can include a sub-category 126, such as “(43) home on” which includes the sub-category 126 to further expand the descriptive term. Alternatively, the real-estate agent can just as easily select “(2) two”, “(36) bedroom”, “(44) duplex”, “(72) on a private lot” to advertise a different real-estate listing for a “two bedroom duplex on a private lot”.

The user interface 102 includes a selectable language feature 128 and a selectable accent feature 130 (shown as drop-down menu selections) via which a user can also select a language and/or an accent of the language in which the audio description can be generated. For example, a real-estate agent wanting to market a home for sale in a predominately Russian community within a city can select to have the description of the real-estate generated in the Russian language. In another instance, an agent can select to have the description of real-estate generated in the English language and then select an associated accent such that the description is verbalized in English with a particular pronunciation, inflection, tone, emphasis, region association, and the like. Although not shown, the user interface 102 can also be implemented to include user-selectable features to initiate generating a description as verbalized by a man or a woman, and optionally, in a selected language and/or selected accent.

When the descriptive, selectable identifiers are selected, the computing-based device 104 correlates the selected ones of the identifiers with the respective parsed voice prompts and generates the description of real-estate, a vehicle, a medical-related state, a commodity, and the like. The description can be saved as a media file 132 which is then maintained by the computing-based device 104 such that the description is accessible when requested. A description of a commodity can be maintained in a media file 132 as any combination of the selected number identifiers 134, as the individual parsed voice prompts 136, as an audio rendition 138 of the description, and/or as a video presentation or animation 140 of the description that is generated from images and/or video clips corresponding to the parsed voice prompts utilized to generate the description of the commodity.

A description of a commodity can include a recorded message 142 which can also be maintained as a media file 132. The recorded message 142 can be combined with a generated message, such as the audio rendition 138 generated from the parsed voice prompts, to describe a commodity. Alternatively, and/or in addition, a description of a commodity can be generated from a first message and at least a second message, such as a first message generated with parsed voice prompts that correspond to selected ones of the selectable identifiers and a second message generated with additional parsed voice prompts that correspond to additional selected ones of the selectable identifiers.

The description of a commodity maintained in a media file 132 can be automatically updated when a previously selected one of the selectable identifiers is unselected or changed via the user interface 102, or when an additional selectable identifier is selected via the user interface 102. For example, the real-estate agent can simply change the description of the “three bedroom home on eight acres” to a “three bedroom home on nine acres” by selecting “(99) nine” on the user interface 102. As such, any one or more of the descriptions saved in the media file 132 can be automatically updated to incorporate the change in the description of the real-estate without the agent having to completely re-record an updated description of the home for sale.

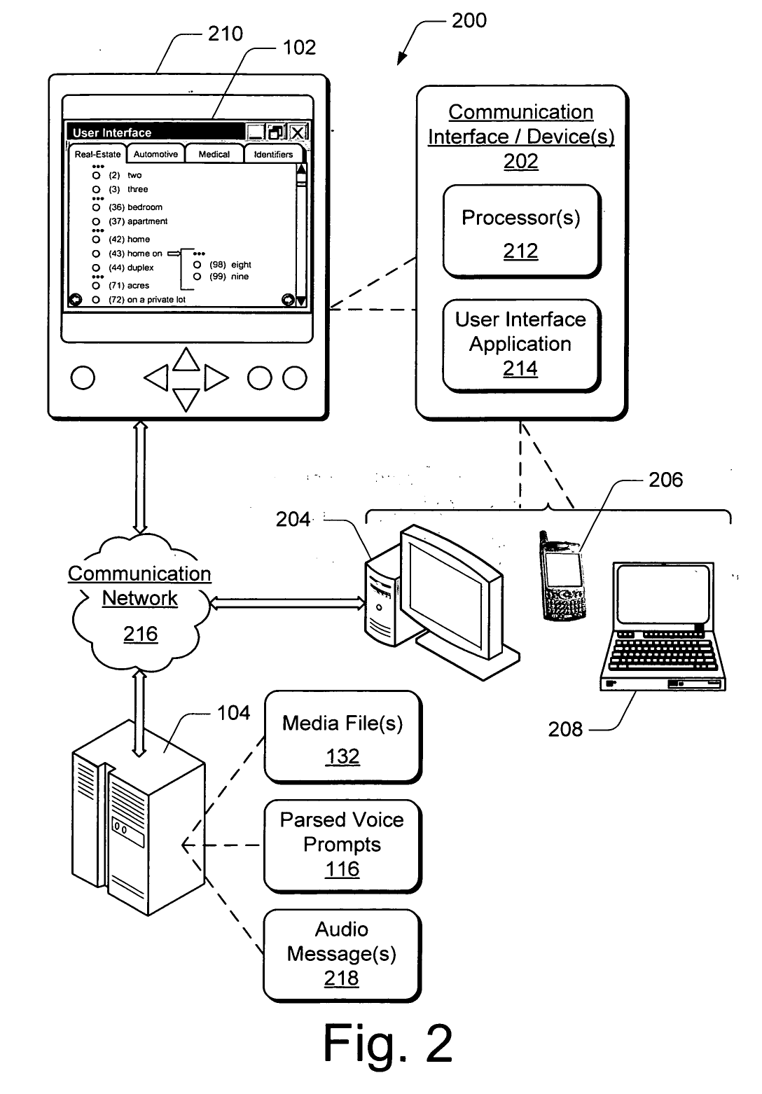

FIG. 2 illustrates examples of various devices 200 which can be implemented in embodiment(s) of selectable voice prompts as communication, interface, and/or computing-based devices 202, such as a desktop computer 204 or any combination of a cell phone 206, portable computer 208, or computing-based communication device 210, such as a PDA (personal digital assistant). A device 202 includes one or more processor(s) 212 (e.g., any of microprocessors, controllers, and the like) and a user interface application 214 that can be implemented as any type of Web-based or device-specific user interface application that is executable by the processor(s) 212 to generate a user interface, such as user interface 102 on device 210. Additionally, any of the various devices 202 can be implemented with any one or more of the differing components described below with reference to the example computing-based device shown in FIG. 5.

The user interface 102 can also be generated for display on the desktop computer 204, cell phone 206, or portable computer 208 to implement embodiments of selectable voice prompts. For example, a real-estate agent can create a description of a real-estate listing utilizing the portable computer 208 while working directly with the seller at the property to obtain the seller's input and approval, rather than having to record a voice message at a later time and then having to follow-up with another appointment.

Any of the various devices 202 can be utilized to select identifiers via the user interface 102 to generate a description of a commodity from corresponding parsed voice prompts 116. Any of the systems and/or devices 202 can be configured for network access and communication in any number of embodiments and varieties of implementation. A communication network 216 can be implemented as any one or combination of a wide area network (e.g., the Internet), a local area network (LAN), an intranet, an IP-based network, broadcast network, a public telephone network, a wireless network, or other data communication network. Additionally, communication network 216 can be implemented using any type of network topology and any network communication protocol, and can be represented or otherwise implemented as a combination of two or more networks.

The cell phone 206, communication network 216, and computing-based and/or telecommunication device 104 can be implemented as a telecommunication system via which a call source (e.g., a phone either wired or wireless, a VOIP-enabled device, and the like) can request the description of a commodity. The request can be communicated to the device 104 which maintains the description of the commodity as a media file 132, and the device 104 can then communicate the audio description as an audio message 218 to the call source. For example, an audio message 218 can be communicated as a recording and/or as a recorded voice message communicated as voicemail to the call source.

In various embodiments of selectable voice prompts, a call source can initiate a request for a description of a commodity as a telephone call, as a text message, or as any other type of telecommunication or Web-based request. In addition, or as an alternative, to receiving the requested description of a commodity as an audio or recorded message, the call source can be prompted with options to receive a text message (SMS) or initiate that an email message be communicated to an email account associated with the call source. An email message communicated to the call source can include an attached audio description of the commodity. In an embodiment, a description of a commodity delivered as a text message can be abbreviated, such as to include a brief description of the commodity for sale and the sale price.

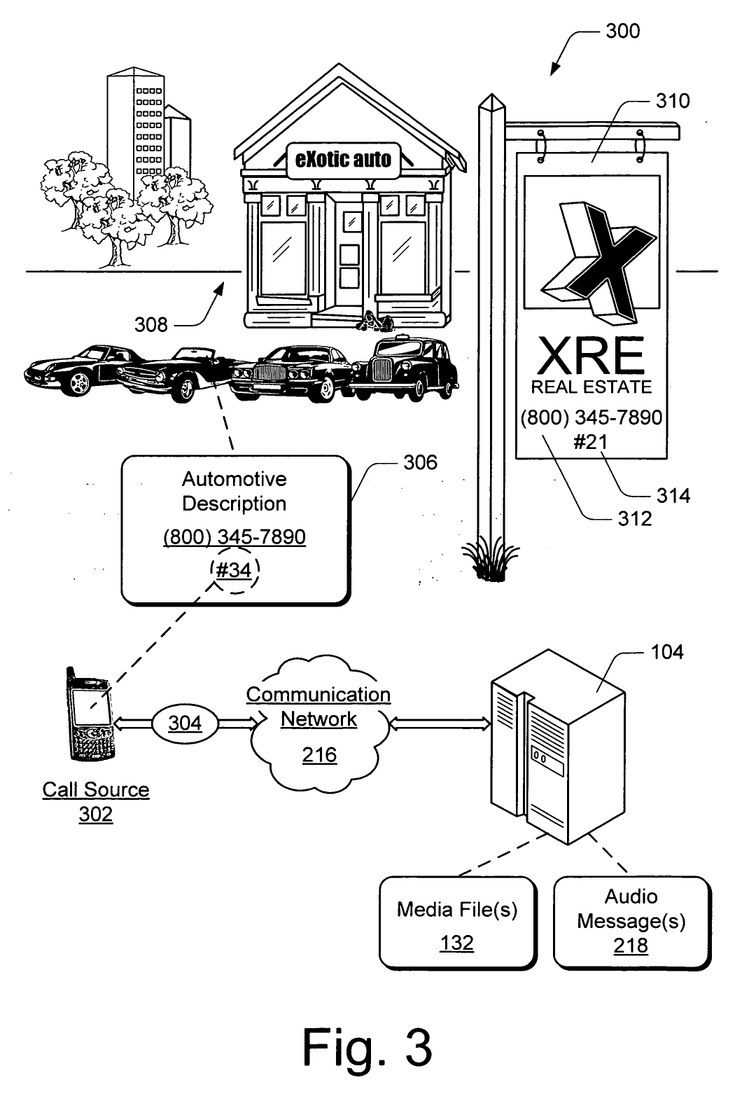

FIG. 3 illustrates example implementation(s) 300 of selectable voice prompts. A call source 302 can initiate a request 304 via the communication network 216 for an audio description of a vehicle which is posted 306 for sale. Similarly, the call source 302 can initiate the request 304 to learn about a real-estate listing 308 for an auto dealership that is posted 310 to include a toll-free number 312 and an option selection 314 to initiate receiving the description of the real-estate 308. Alternatively, the call source 302 can initiate communication with a Web-based service and access the option selection 314 to initiate receiving the description of the commodity.

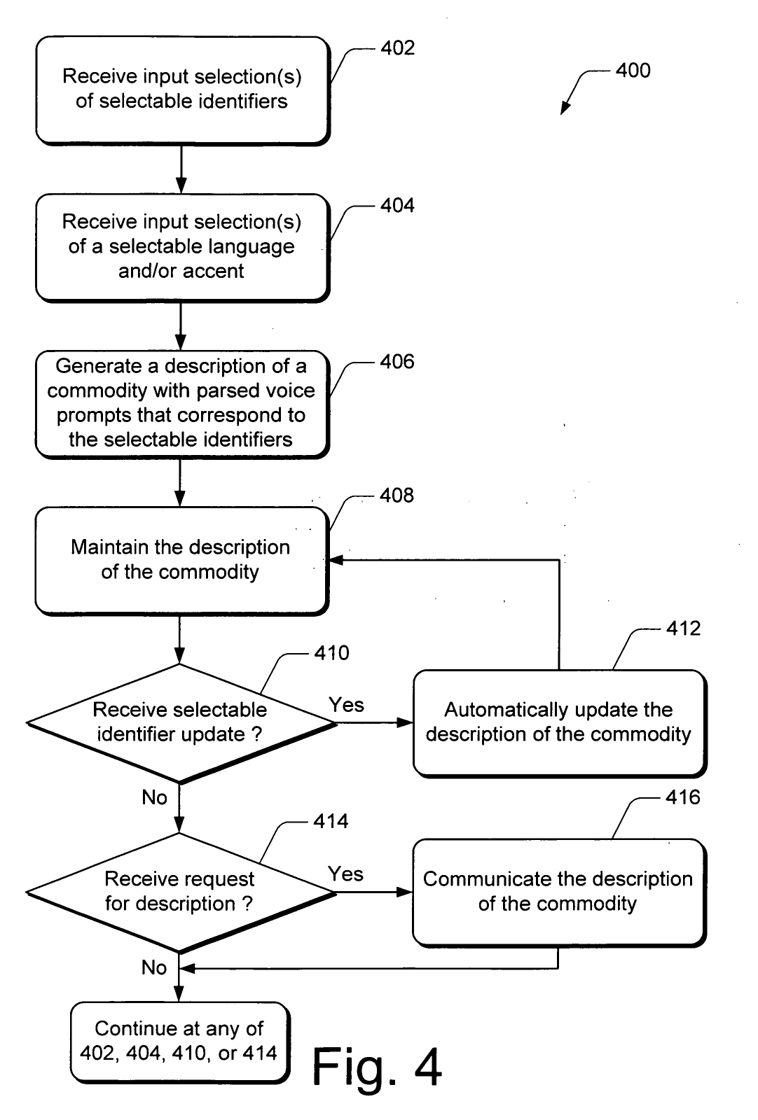

Generally, any of the functions and methods described herein can be implemented using hardware, software, firmware (e.g., fixed logic circuitry), manual processing, or any combination thereof. A software implementation represents program code that performs specified tasks when executed on a computing-based processor. Example method 400 described with reference to FIG. 4 may be described in the general context of computer executable instructions. Generally, computer executable instructions can include applications, routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices. Further, the features described herein are platform-independent such that the techniques may be implemented on a variety of computing platforms having a variety of processors.

FIG. 4 illustrates an example method 400 for selectable voice prompts and is described with reference to the example system(s), device(s), and implementation(s) shown in FIGS. 1-3. The order in which the method is described is not intended to be construed as a limitation, and any number of the described method blocks can be combined in any order to implement the method, or an alternate method.

At block 402, input selection(s) of selectable identifiers are received from which a description of a commodity can be generated. For example, selectable identifiers can be received as user-selectable inputs via user interface 102 which displays the selectable identifiers as the descriptive real-estate terms 108, descriptive automotive terms 110, descriptive medical terms 112, and/or as any other type of selectable identifiers 106. The descriptive real-estate terms 108 can be selected from which the description of real-estate is generated with corresponding parsed voice prompts. Similarly, the descriptive automotive terms 110 can be selected from which the description of a vehicle is generated with corresponding parsed voice prompts, and/or the descriptive medical terms 112 can be selected from which the description of a medical-related state can be generated with corresponding parsed voice prompts.

At block 404, input selection(s) of a selectable language and/or an accent are received in which the description of the commodity can be generated. For example, user-selectable inputs of a language 128 and/or an associated accent 130 can be received via user interface 102, and the description of a commodity can be generated in the selected language and/or associated accent.

At block 406, the description of the commodity is generated with parsed voice prompts that correspond to selected ones of the selectable identifiers. For example, parsed voice prompts 116 maintained by device 104 that correspond to selected ones of the descriptive real-estate terms 108 can be sequenced to describe real-estate, such as a property, a house, a building, and the like. Similarly, parsed voice prompts 116 that correspond to selected ones of the descriptive automotive terms 110 can be sequenced to describe a vehicle, and/or parsed voice prompts 116 that correspond to selected ones of the descriptive medical terms 112 can be sequenced to describe a medical-related state, such as a condition, state of health, and the like.

At block 408, the description of the commodity generated with the parsed voice prompts is maintained. For example, the description of the commodity can be saved or maintained by the computing-based device 104 such that the description is accessible when requested. The description of a commodity can be maintained in a media file 132 as any combination of the selected number identifiers 134, as the individual parsed voice prompts 136, as the audio rendition 138 of the description, and/or as a video presentation or animation 140 of the description.

At block 410, a determination is made as to whether a selectable identifier update is received. For example, a previously selected one of the selectable identifiers may be unselected or changed via the user interface 102, or an additional selectable identifier may be selected via the user interface 102. If a selectable identifier update is received (i.e., “yes” from block 410), then the description of the commodity is automatically updated at block 412. The updated description of the commodity is then maintained at block 408 as described above.

If a selectable identifier update is not received (i.e., “no” from block 410), a determination is made as to whether a request for the description of the commodity is received at block 414. If a request for the description of the commodity is received (i.e., “yes” from block 414), then the description of the commodity is communicated at block 416. For example, a request for a description of a commodity may be received as a telecommunication request or via a Web-based service. The description of the commodity can then be communicated as an audio rendition of the parsed voice prompts and/or as a video presentation of the parsed voice prompts.

The description of the commodity can be communicated as an audio message 218, such as a recording or voicemail message to the requesting communication device. The description of the commodity can also be communicated as a text message or as an email message to an email account associated with the requesting device or user. If a request for the description of the commodity is not received (i.e., “no” from block 414), or after the description of the commodity is communicated (at block 416), the method can continue at any of the blocks 402, 404, 410, or 414.

FIG. 5 illustrates an example computing-based device 500 that can be implemented as any one or more computing, electronic, communication, or other type of device in a selectable voice prompts system. For example, the computing-based device 500 can be implemented as the computing-based device 104 shown in FIGS. 1-3, and as any of the other interface, communication, and/or computing-based devices 202, 302 described herein.

Computing-based device 500 includes one or more media content inputs 502 which may include Internet Protocol (IP) inputs to receive data via an IP-based network. Device 500 further includes communication interface(s) 504 which can be implemented as any one or more of a serial and/or parallel interface, a wireless interface, any type of network interface, a modem, and as any other type of communication interface. A wireless interface enables device 500 to receive data from an input device, such as from an infrared (IR), 802.11, Bluetooth, or similar RF input device.

A network interface provides a connection between the computing-based device 500 and a communication network by which other electronic and computing devices can communicate data with device 500. Similarly, a serial and/or parallel interface provides for data communication directly between computing-based device 500 and the other electronic or computing devices. A modem facilitates device 500 communication with other electronic and computing devices via a conventional telephone line, a DSL connection, cable, and/or other type of communication connection.

Computing-based device 500 also includes one or more processors 506 (e.g., any of microprocessors, controllers, and the like) which process various computer executable instructions to control the operation of device 500, to communicate with other electronic and computing devices, and to implement embodiments of selectable voice prompts. Computing-based device 500 can be implemented with computer readable media 508, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 508 provides data storage mechanisms to store various information and/or data such as software applications and any other types of information and data related to operational aspects of client device 500. For example, an operating system 510 and/or other application programs 512 can be maintained as software applications with the computer readable media 508 and executed on processor(s) 506 to implement embodiments of selectable voice prompts. For example, computing-based device 500 can be implemented to include a user interface application, such as user interface application 214 of a communication and/or interface device 202. The computer readable media 508 also maintains media files 514, such as a description of a commodity, and/or audio messages 516.

The computing-based device 500 also includes an audio and/or video output 518 to provide audio and video data to an audio rendering and/or display system 520, or to other devices that process, display, and/or otherwise render audio, video, and image data. Video signals and audio signals can be communicated from device 500 to a display device 522 via an RF (radio frequency) link, S-video link, composite video link, component video link, analog audio connection, or other similar communication link. Alternatively, the audio rendering and/or display system 520 is/are integrated components of the computing-based device 500.

Although shown separately, some of the components of the computing-based device 500 can be implemented in an application specific integrated circuit (ASIC). Additionally, a system bus (not shown) typically connects the various components within device 500. A system bus can be implemented as one or more of any of several types of bus structures, including a memory bus or memory controller, a peripheral bus, an accelerated graphics port, or a local bus using any of a variety of bus architectures.

Although selectable voice prompts has been described in language specific to structural features and/or methods, it is to be understood that the subject of the appended claims is not necessarily limited to the specific features or methods described. Rather, the specific features and methods are disclosed as exemplary implementations of selectable voice prompts.

1. A selectable voice prompts system, comprising:
selectable identifiers configured for selection to describe a commodity via parsed voice prompts that correspond to selected ones of the selectable identifiers; and
a description of the commodity generated from the parsed voice prompts that correspond to the selected ones of the selectable identifiers, the description of the commodity being accessible to render the description when requested.

2. A selectable voice prompts system as recited in claim 1, further comprising a user interface via which the selectable identifiers are displayed for selection.

3. A selectable voice prompts system as recited in claim 1, further comprising a media file configured to maintain at least one of: the selected ones of the selectable identifiers from which the description of the commodity can be generated; the parsed voice prompts that correspond to the selected ones of the selectable identifiers; the description of the commodity.

4. A selectable voice prompts system as recited in claim 3, wherein the media file can be requested to initiate an audio rendition of the description of the commodity as the parsed voice prompts.

5. A selectable voice prompts system as recited in claim 1, further comprising a media file configured to maintain at least one of: the description of the commodity as a video presentation of the parsed voice prompts that correspond to the selected ones of the selectable identifiers; a video animation of the parsed voice prompts that correspond to the selected ones of the selectable identifiers.

6. A selectable voice prompts system as recited in claim 1, wherein:
the description of the commodity can be generated from a first message and at least a second message;
the first message being generated from the parsed voice prompts that correspond to the selected ones of the selectable identifiers; and
the at least second message being generated from additional parsed voice prompts that correspond to additional selectable identifiers configured for selection to further describe the commodity.

7. A selectable voice prompts system as recited in claim 6, wherein the description of the commodity can be generated from the first message followed by the at least second message, or the at least second message followed by the first message.

8. A selectable voice prompts system as recited in claim 1, wherein the description of the commodity includes a recorded message combined with a generated message from the parsed voice prompts that correspond to the selected ones of the selectable identifiers.

9. A selectable voice prompts system as recited in claim 1, wherein the description of the commodity is accessible via a telecommunication request which is configurable to initiate the description as the parsed voice prompts.

10. A selectable voice prompts system as recited in claim 1, wherein the selectable identifiers are descriptive real-estate terms, and wherein the parsed voice prompts correspond to selected ones of the descriptive real-estate terms to describe real-estate.

11. A selectable voice prompts system as recited in claim 1, wherein the selectable identifiers are descriptive automotive terms, and wherein the parsed voice prompts correspond to selected ones of the descriptive automotive terms to describe a vehicle.

12. A selectable voice prompts system as recited in claim 1, wherein the selectable identifiers are descriptive medical terms, and wherein the parsed voice prompts correspond to selected ones of the descriptive medical terms to describe a medical-related state.

13. A selectable voice prompts system as recited in claim 1, wherein the description of the commodity is configured to be automatically updated when at least one of: a selected one of the selectable identifiers is unselected; an additional selectable identifiers is selected.

14. A selectable voice prompts system as recited in claim 1, wherein the selectable voice prompts system is a Web-based service.

15. A telecommunications system that includes the selectable voice prompts system as recited in claim 1, the telecommunications system configured to:
receive a telecommunication request for the description of the commodity from a communication device; and
communicate the description of the commodity to the communication device as at least one of: an audio message; a voicemail message; a text message; an email message.

16. A user interface comprising selectable identifiers from which an audio description can be generated from corresponding parsed voice prompts.

17. A user interface as recited in claim 16, wherein the user interface is a Web-based user interface via which one or more of the selectable identifiers can be user-selected to describe a commodity via the corresponding parsed voice prompts.

18. A user interface as recited in claim 16, wherein the user interface is configured for display on a portable device via which one or more of the selectable identifiers can be user-selected to describe a commodity via the corresponding parsed voice prompts.

19. A user interface as recited in claim 16, wherein the selectable identifiers are descriptive real-estate terms from which the audio description of real-estate can be generated from the corresponding parsed voice prompts.

20. A user interface as recited in claim 16, wherein the selectable identifiers are descriptive automotive terms from which the audio description of a vehicle can be generated from the corresponding parsed voice prompts.

21. A user interface as recited in claim 16, wherein the selectable identifiers are descriptive medical terms from which the audio description of a medical-related state can be generated from the corresponding parsed voice prompts.

22. A method, comprising:
receiving input selections of selectable identifiers from which a description of a commodity can be generated;
generating the description of the commodity with parsed voice prompts that correspond to selected ones of the selectable identifiers; and
communicating the description of the commodity when requested.

23. A method as recited in claim 22, wherein the input selections are received as user-selectable inputs via a user interface that displays the selectable identifiers.

24. A method as recited in claim 22, further comprising maintaining the description of the commodity as at least one of: the selected ones of the selectable identifiers; the parsed voice prompts that correspond to the selected ones of the selectable identifiers; an audio rendition of the description of the commodity.

25. A method as recited in claim 22, further comprising maintaining the description of the commodity as at least one of: a video representation of the parsed voice prompts that correspond to the selected ones of the selectable identifiers; a video animation of the parsed voice prompts that correspond to the selected ones of the selectable identifiers.

26. A method as recited in claim 22, further comprising receiving a request for the description of the commodity, and wherein the description of the commodity is communicated as an audio rendition of the parsed voice prompts.

27. A method as recited in claim 22, further comprising receiving a request for the description of the commodity, and wherein the description of the commodity is communicated as a video presentation.

28. A method as recited in claim 22, further comprising receiving a telecommunication request for the description of the commodity from a communication device, and wherein the description of the commodity is communicated to the communication device as at least one of: an audio message; a voicemail message; a text message; an email message.

29. A method as recited in claim 22, wherein the selectable identifiers are descriptive property terms from which the description of real-estate is generated with the parsed voice prompts that correspond to selected ones of the descriptive property terms.

30. A method as recited in claim 22, wherein the selectable identifiers are descriptive automotive terms from which the description of a vehicle is generated with the parsed voice prompts that correspond to selected ones of the descriptive automotive terms.

31. A method as recited in claim 22, wherein the selectable identifiers are descriptive medical terms from which the description of a medical-related state is generated with the parsed voice prompts that correspond to selected ones of the descriptive medical terms.

32. A method as recited in claim 22, further comprising automatically updating the description of the commodity.

33. A method as recited in claim 32, further comprising receiving an additional input selection to at least one of: unselect a selected one of the selectable identifiers such that the description of the commodity is automatically updated; select an additional selectable identifier such that the description of the commodity is automatically updated.

34. A method as recited in claim 22, wherein the description of the commodity includes a recorded message combined with a generated message from the parsed voice prompts that correspond to the selected ones of the selectable identifiers, and wherein the description of the commodity is communicated as the recorded message and the generated message when requested.
